(19) United States
(12) Patent Application Publication
(10) Pub. No.: US 2008/0162804 A1
(43) Pub. Date: Jul. 3, 2008

(54) MAGNETIC DISK APPARATUS AND CONTROL METHOD

(75) Inventor: Ikuko Iida, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/958,008

(22) Filed: Dec. 17, 2007

(30) Foreign Application Priority Data
Dec. 27, 2006 (JP) 2006-353370

(51) Int. Cl. G06F 12/14

(52) U.S. Cl. 711/112; 711/E12.094

(57) ABSTRACT

According to one embodiment, a magnetic disk apparatus comprises a storage-medium unit including a storage medium, a magnetic-disk medium unit including a magnetic disk medium, a storing unit configured to store data transmitted from a host system in the storage medium, a first comparator configured to compare an input password with a password stored in the storage medium or in a semiconductor memory provided on a substrate on which the storage medium is provided, and a control unit provided in the storage-medium unit and configured to control an access to the magnetic disk medium in accordance with a comparison result obtained by the first comparator.

### CROSS-REFERENCE TO RELATED APPLICATIONS

This application is based upon and claims the benefit of priority from Japanese Patent Application No. 2006-353370, filed Dec. 27, 2006, the entire contents of which are incorporated herein by reference.

### BACKGROUND

1. Field

One embodiment of the present invention relates to a magnetic disk apparatus such as a hard disk drive, and also to a method of controlling the magnetic disk apparatus.

2. Description of the Related Art

Generally, the operating system of a computer is stored in the hard disk drive that is used as magnetic disk apparatus. Therefore, to activate the computer, the hard disk drive is first started, reading the operating system, and the operating system is executed. In the hard disk drive, a considerably long time elapses until the motor reaches a constant rotational speed after the hard disk drive is powered on. Due to this time, the computer cannot be activated as fast as is desired.

A password is set in the computer, disabling any person other than the authenticated user. The password is stored in the hard disk. The password stored in the hard disk drive is compared with the password input at the time of activating the computer. If the input password is correct, or equal to the password stored in the hard disk drive, the access to the data stored in the hard disk drive is permitted. The operating system can therefore be read from the hard disk drive. This procedure enhances the security of the hard disk drive.

In recent years, the storage capacity of flash memories has increased. Hybrid hard disk drives having a flash memory have been developed, in which the operating system is stored in the flash memory, not in a hard disk. The operating system is instantaneously read from the flash memory to activate the computer incorporating the hard disk drive. The password for authenticating the user is, however, stored in the magnetic disk drive. Here arises a problem. Since the input password used to authenticate the user is stored in the hard disk drive, it takes some time to activate the hard disk drive though the operating system can be read from the flash memory in a short time. Consequently, the time required to activate the computer cannot be shorted as much as is desired.

Encrypting/decrypting devices are known, which are used to collate passwords, as disclosed in, for example, Jpn. Pat. Appln. KOKAI Publication No. 11-161167. The device disclosed in Jpn. Pat. Appln. KOKAI Publication No. 11-161167 generates a one-time key every time plain-text data is encrypted, so that a person entrusted with the secret key from the authenticated user may decrypt the encrypted data. Using the one-time key, that person encrypts plain-text data, generating encrypted data. The one-time key is encrypted by using the user's private key and the public key, generating a first encryption key and a second encryption key. In order to decrypt the encrypted data, the user decrypts the first encryption key by using the user's private key, thereby acquiring the one-time key. To decrypt the encrypted data, the person entrusted with the secret key uses the secret key, decrypting the second encryption key. As a result, the person acquires the one-time key.

Jpn. Pat. Appln. KOKAI Publication No. 11-161167 does not relate to the collation of an input password with the password stored in a hard disk drive. The publication does not describe any password collation that is performed to discriminate the authenticated user, when the operating system stored in the flash memory incorporated in the hard disk drive is activated.

### BRIEF SUMMARY OF THE INVENTION

According to an embodiment of the present invention, a magnetic disk apparatus comprises a storage-medium unit including a storage medium, a magnetic-disk medium unit including a magnetic disk medium, a storing unit configured to store data transmitted from a host system in the storage medium, a first comparator configured to compare an input password with a password stored in the storage medium or in a semiconductor memory provided on a substrate on which the storage medium is provided, and a control unit provided in the storage-medium unit and configured to control an access to the magnetic disk medium in accordance with a comparison result obtained by the first comparator.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the configuration of a hard disk drive according to an embodiment of the present invention;

FIG. 2 is an exemplary diagram depicting the configuration of the flash memory shown in FIG. 1;

FIG. 3 is an exemplary flowchart explaining the process of setting a password in the embodiment of the present invention;

FIG. 4 is an exemplary flowchart explaining the process of activating the hard disk drive according to the embodiment of this invention; and

FIGS. 5A, 5B, 5C, 5D, 5E, 5F, 5G, 5H, 5I, 5J and 5K are exemplary timing charts showing the process of activating the hard disk drive according to the embodiment of this invention.

### DETAILED DESCRIPTION

Various embodiments according to the invention will be described hereinafter with reference to the accompanying drawings. In general, according to one embodiment of the invention, a magnetic disk apparatus comprises a storage-medium unit including a storage medium, a magnetic-disk medium unit including a magnetic disk medium, a storing unit configured to store data transmitted from a host system in the storage medium, a first comparator configured to compare an input password with a password stored in the storage medium or in a semiconductor memory provided on a substrate on which the storage medium is provided, and a control unit provided in the storage-medium unit and configured to control an access to the magnetic disk medium in accordance with a comparison result obtained by the first comparator.

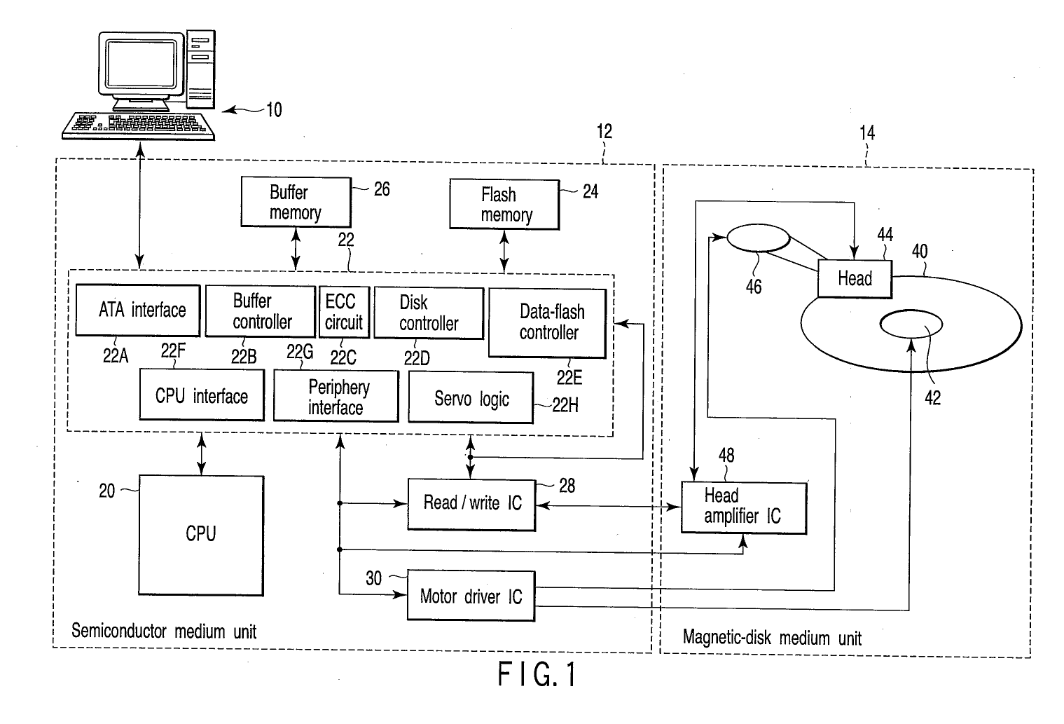

According to an embodiment, FIG. 1 is an exemplary diagram showing the configuration of a hybrid hard disk drive according to a first embodiment of this invention, which incorporates a flash memory. The hybrid hard disk drive according to the embodiment is connected to a host system 10 by, for example, an ATA (IDE) bus. The hard disk drive comprises a semiconductor medium unit 12 and a magnetic-disk medium unit 14. The semiconductor medium unit 12 is mounted on a circuit board. The magnetic-disk medium unit 14 is used as disk-medium unit. The hard disk drive (semiconductor medium unit 12 and magnetic-disk unit 14) may be either an internal one provided in the housing of the host system 10 (i.e., personal computer) or an external one provided outside the housing.

The semiconductor medium unit 12 includes a CPU 20, a hard disk controller 22, a flash memory 24, a buffer memory 26, a read/write IC 28, and a motor driver IC 30. The CPU 20 (including a RAM and a ROM) is, for example, a 32-bit CPU. The buffer memory 26 has a storage capacity of, for example, 16 MB. The hard disk controller 22 includes an ATA interface 22A, a buffer controller 22B, an ECC circuit 22C, a disk controller 22D, a data-flash controller 22E, a CPU interface 22F, a periphery interface 22G, and a servo logic unit 22H.

The magnetic-disk medium unit 14 includes a disk (magnetic disk medium) 40. The disk 40 has a recording surface on, for example, the upper side. On the recording surface, data can be magnetically recorded. A head (magnetic head) 44 is arranged, opposing the recording surface of the disk 40. The head 44 can write (record) and read (reproduce) in and from the disk 40. The lower side (not shown) of the disk 40 is a recording surface, too. Another head similar to the head 44 is arranged, opposing this recording surface. As shown in FIG. 1, the hard disk drive has only one disk 40. Nonetheless, the hard disk drive may have a plurality of disks 40, one laid above another.

A spindle motor 42 rotates the disk 40 at high speed. The head 44 is secured to an actuator (not shown) that works as head-moving mechanism. More precisely, the head 44 is attached to a suspension that extends from the arm of the actuator. The actuator has a bearing unit fastened to the bottom of the case of the hard disk drive, which functions as a base. The arm protrudes from the bearing unit. The actuator has a support frame shaped like, for example, letter V and protruding in the direction opposite to the direction the arm protrudes. The actuator can rotate around the bearing unit. As the actuator so rotates, the head 44 rotates because it is coupled by the arm to the suspension. Therefore, the head 44 can move in the radial direction of the disk 40, to a target track provided on the disk 40. The actuator is driven by a voice coil motor 46, i.e., actuator driver. The spindle motor 42 and the voice coil motor 46 are driven with a drive current that is supplied from the motor driver IC 30 provided in the semiconductor medium unit 12.

The head 44 is connected to a head amplifier circuit (head amplifier IC) 48. The head amplifier IC 48 is connected to the read/write circuit (read/write IC) 28 incorporated in the semiconductor medium unit 12. The read/write circuit 28 has a read amplifier and a write amplifier. The read amplifier amplifies a read signal read by the head 44. The write amplifier converts write data into a write current, which will be supplied to the head 44. The read/write circuit 28 is a signal-processing device that processes various signals. The read/write circuit 28 performs analog-to-digital conversion on a read signal amplified by the head amplifier IC 48. The read/write circuit 28 also performs servo detection (servo decoding), extracting servo data from the digital data generated through the analog-to-digital conversion. The servo data thus extracted is supplied to the hard disk controller 22. The read/write circuit 28 extracts a cylinder address, a sector address and burst data (PES) from the servo data. The cylinder address, a sector address and burst data are supplied to the CPU 20. Further, the read/write circuit 28 encodes the write data and decodes the read data.

The read/write circuit 28 is connected to the hard disk controller 22 and the CPU 20. The hard disk controller 22 is connected to the CPU 20 and the host system 10 (i.e., digital apparatus such as a personal computer) that uses the hard disk drive). The hard disk controller 22 transmits and receives commands and data to and from the host system 10 and controls the data transfer between the read/write circuit 28 and the disk 40.

The CPU 20 is the main controller in the hard disk drive shown in FIG. 1. The CPU 20 includes a flash memory (not shown) and a RAM (not shown, either). The flash memory is a programmable nonvolatile memory that stores control programs that can be executed by the CPU 20. A part of the storage area of the RAM is used as a work area for the CPU 20.

The flash memory 24 is, for example, an EEPROM of NAND type that is an electrically programmable memory. The flash memory 24 can keep storing data even if it is not supplied with electric power. Therefore, the flash memory 24 stores data for a long time, unlike the RAM incorporated in the CPU 20 and the buffer memory 26. In this embodiment, the flash memory 24 is used to store data other than the data that is recorded on the disk 40. Nevertheless, the flash memory 24 is used to store a part of the data recorded on the disk 40, like the buffer memory 26, in order to raise the access speed.

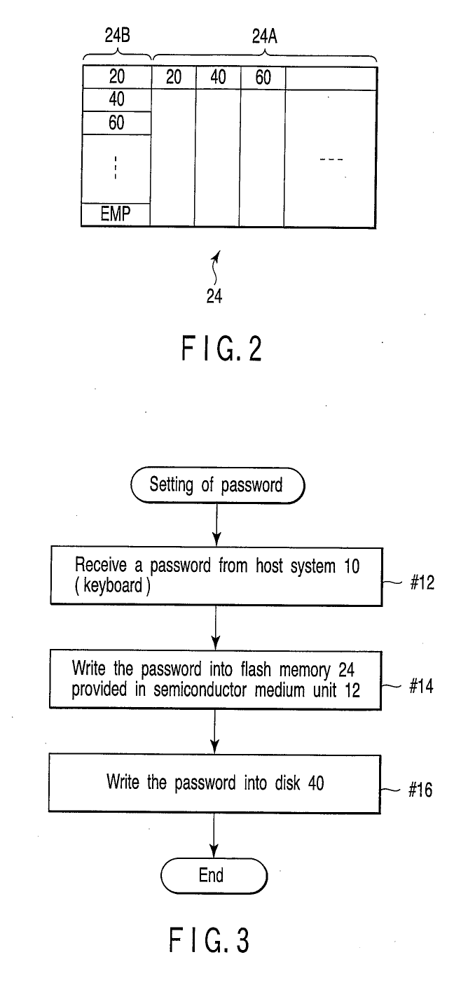

As shown in FIG. 2, the flash memory 24 has not only a data storage area 24A, but also a management data storage area 24B. The management data storage area 24B is provided to store the logical block addresses (LBA) of the data stored in the data storage area 24A. In the instance of FIG. 2, LBAs 20, 40, 60 . . . are stored in the management data storage area 24B. In the management data storage area 24B, the free storage capacity EMP of the data storage area 24A is recorded. The CPU 20 of the semiconductor medium unit 12 can therefore refer to the management data storage area 24B when it receives a read address (logical block address) from the host system 10, thereby to determine whether the data at the address is stored in the flash memory 24 or the disk 40. When the host system 10 informs the CPU 20 of the size of data to write, the CPU 20 refers to the free storage capacity EMP recorded in the management data storage area 24B. Then, the CPU 20 determines whether the data can be stored in the flash memory 24 or in the disk 40. Instead, the host system 10 may determine whether the data should be written or read in or from the flash memory 24 or should be written or read in or from the disk 40, and then may instruct the hard disk drive to write or read the data in or from the flash memory 24 or in or from the disk 40.

The flash memory 24 stores the operating system for activating the host system 10 (i.e., computer). Hitherto, the operating system is stored in the disk 40. To read the operating system and execute it, the magnetic-disk medium unit 14 (including spindle motor 42 and voice coil motor 46) must be operated to rotate the disk 40 stably at a constant speed and to position the head 44 at a target track. Inevitably, the operating system cannot be read until the rotation speed of the spindle motor 42, in particular, becomes stable. Consequently, the host system 10 (i.e., computer) cannot be activated immediately.

In the present embodiment, the flash memory 24 stores the operating system. Therefore, the magnetic-disk medium unit 14 need not be operated before the host system 10 (i.e., computer) is activated. The operating system can be executed within a short time after the host system 10 is turned on. This can shorten the time required to activate the host system 10 (i.e., computer). The storage medium for storing the operating system is not limited to the flash memory 24. A nonvolatile memory of any other type can be used instead. For example, the flash memory incorporated in the CPU 20 may be used in place of the flash memory 24. Further, the operating system may be stored in the RAM provided in the CUP 20 if this RAM is battery-driven at all times.

The present embodiment is a high-security system in which any input password must be compared with the stored password to access the flash memory 24 and the disk 40.

FIG. 3 is an exemplary flowchart explaining the process of setting a password. The hard disk drive (HDD) according to this embodiment is usually locked. The hard disk drive is unlocked only when a password input is equal to the correct (stored) password, permitting an access to the data stored in the flash memory 24 and the disk 40. The correct password should therefore be set in the hard disk drive beforehand. When the host system 10 (i.e., personal computer) is used for the first time, it displays a password-setting menu on the screen. In accordance with this menu, the user performs the process of FIG. 3, setting a password. The process can be performed at any time desired, in order to renew the password.

To set a password, the user first operates the keyboard of the host system 10, inputting the password (block #12). The password is stored in the buffer memory 26. The password stored in the buffer memory 26 is written into the flash memory 24 of the semiconductor medium unit 12 (block #14). The password may be written into the flash memory provided in the CPU 20, not into the flash memory 24. Alternatively, the password may be written into the RAM provided in the CPU 20 if the RAM is battery-driven at all times. In brief, it suffices to write the password into a nonvolatile memory.

Next, the password now stored in the buffer memory 26 (i.e., the password equal to the password written into the flush memory 24) is written into the disk 40, too (block #16). Thus, the input password is written in both the flash memory 24 and the disk 40. Blocks #14 and #16 may be performed in the reverse order. That is, the password may be written first into the disk 40 and then into the flash memory 24. Alternatively, the password may be written into the disk 40 and flash memory 24 at the same time.

Thus, the password is set (or written into the flash memory 24 and disk 40). To renew the password, a new password is written over the password stored in the flash memory 24 and disk 40.

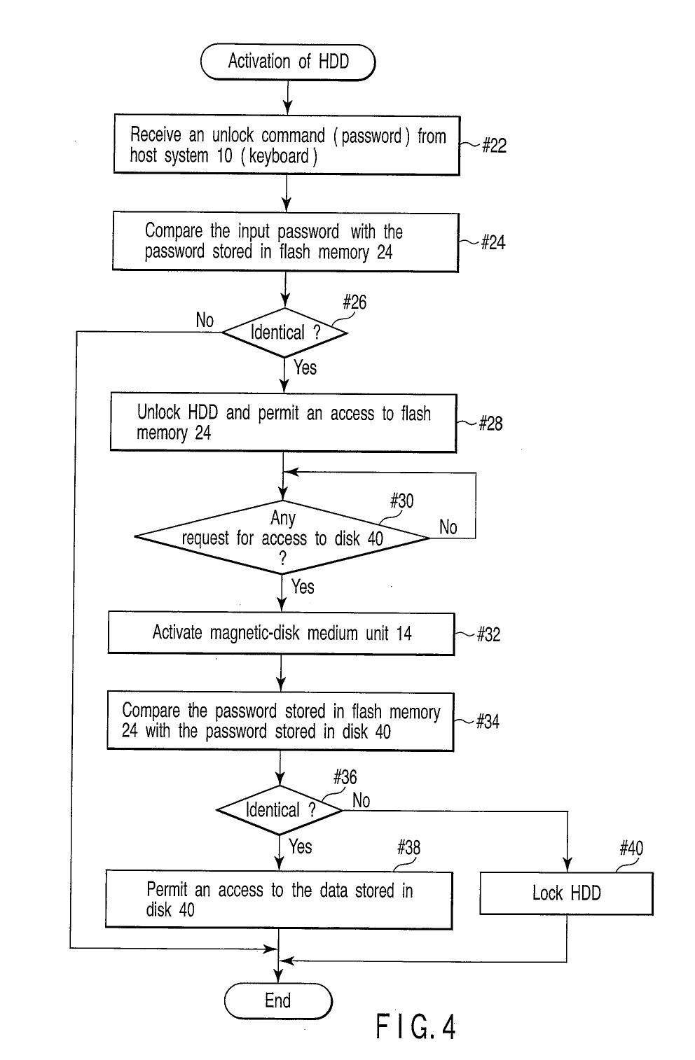

FIG. 4 is an exemplary flowchart explaining the process of activating the hard disk drive, by using the password thus set. The RAM provided in the CPU 20 stores a lock bit for controlling the activation of the hard disk drive. If the lock bit is “1,” the hard disk drive is locked. If it is “0,” the hard disk drive is unlocked. Note that the lock bit is “1” when the host system 10 is turned on. This enhances the security of the hard disk drive.

To activate the hard disk drive, the user first operates the keyboard of the host system 10, inputting an unlock command for unlocking the hard disk drive. More specifically, the user inputs a password equal to the password set in the process of FIG. 3 (block #22). The password input is stored into the buffer memory 26.

In block #24, the password thus input is compared with the password stored in the flash memory 24. In block #26 it is determined whether the passwords compared are equal. If they are equal, the user who has input the password is found to be the authenticated user. In this case, the hard disk drive is unlocked in block #28. More precisely, the lock bit in the RAM of the CPU 20 is changed to “0.” In block #28, not only the hard disk drive is unlocked, but also the access to the data stored in the flash memory 24 is permitted. At this point, the disk 40 remains not accessible. Thereafter, access is made to the data stored in the flash memory 24. Because of the access, the operating system, for example, is then executed, whereby the host system 10 (i.e., computer) can be activated. After the operating system is thus activated, access is made to the data stored in the flash memory 24. Whether certain data should be stored into the flash memory 24 or into the disk 40 may be determined by the host system 10 or by the CPU 20 of the semiconductor medium unit 12, on the basis of the data stored in the management data storage area 24B.

In block #30, a request for access to the data stored in the disk 40 is waited for. The data processing may be completed in the flash memory 24 only. In this case, the magnetic-disk medium unit 14 is not activated at all. Hence, the time required for this data processing does not include the time that elapses before the magnetic-disk unit 14 is activated.

When a request for access to the data stored in the disk 40 comes, the magnetic-disk medium unit 14 is operated in block #32. That is, the spindle motor 42 and the voice coil motor 46 are driven. The head 44 is thereby moved to a position over the target track, and the rotation of the spindle motor 43 becomes stable. Then, the data stored in the disk 40 can be accessed. Then, in block #34, the password stored in the flash memory 24 is compared with the password stored in the disk 40.

In block #36 it is determined whether these passwords compared are equal to each other. If they are found to be equal, the hard disk drive is determined to be an authenticated apparatus. In other words, the semiconductor medium unit 12 attached to the magnetic-disk medium unit 14 is not one removed from any other hard disk drive after the collation in block #26 succeeds and the password of the flash memory 26 is known. Therefore, in block #38, access to the data stored in the disk 40 is permitted.

If the password stored in the flash memory 24 is not equal to the password stored in the disk 40 in block #36, the hard disk drive is determined not to be an authenticated one. Therefore, the hard disk drive is locked (that is, the lock bit is set to “1”) in block #40. The process of activating the hard disk drive is then terminated.

If the password input is not equal to the password stored in the flash memory 24 in block #26, it is determined that the password has been input by an unauthenticated user who does not know the password that has been set. Therefore, the process of activating the hard disk drive is stopped, without unlocking the hard disk drive. At this point, the lock bit remains unchanged (that is, having the value of “1”).

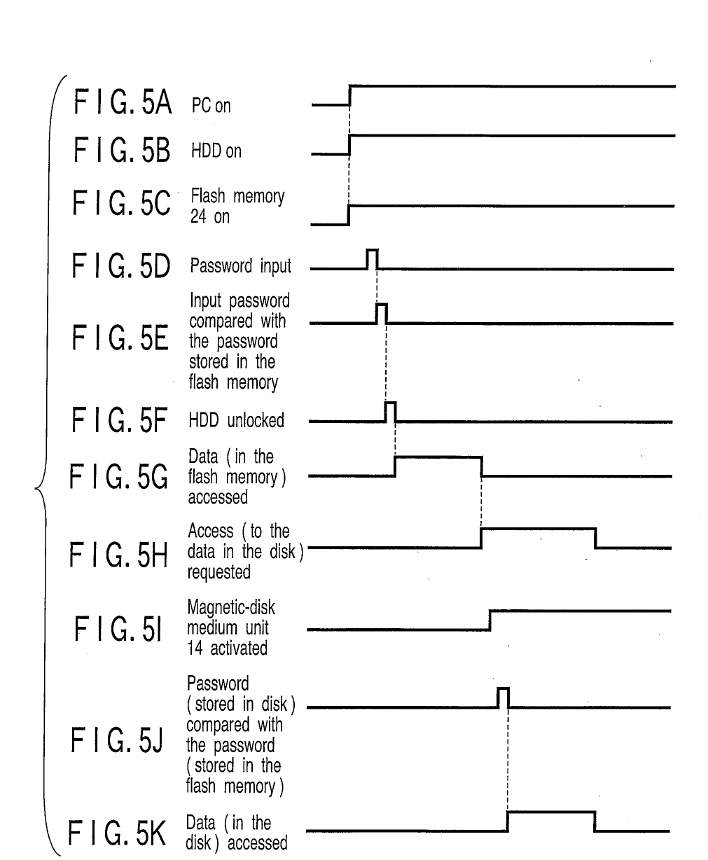

FIGS. 5A, 5B, 5C, 5D, 5E, 5F, 5G, 5H, 5I, 5J and 5K are exemplary timing charts showing the process of activating the hard disk drive.

When the power switch (not shown) provided on the host system 10 is turned on as shown in FIG. 5A, the hard disk drive is turned on as shown in FIG. 5B. At the same time, the flash memory 24 is turned on as shown in FIG. 5C.

Thereafter, the user may input a password as shown in FIG. 5D (block #22, FIG. 4). Then, the input password is compared with the password stored in the flash memory 24 as shown in FIG. 5E (block #24, FIG. 4). If the passwords compared are equal (Yes in block #26), the hard disk drive is unlocked as shown in FIG. 5F (block #28, FIG. 4). Access to the data stored in the flash memory 24 is therefore permitted as shown in FIG. 5G. Thus, the operating system is executed, or data is accessed in the ordinary way (block #28, FIG. 4).

When a request for access to the data stored in the disk 40 comes as shown in FIG. 5H (Yes in block #30, FIG. 4), the magnetic-disk medium unit 14 is operated as shown in FIG. 5I (block #32, FIG. 4). The password is read from the disk 40 and compared with the password stored in the flash memory 24 as shown in FIG. 5J (block #34, FIG. 4). If the passwords compared are equal (Yes in block #36), access to the disk 30 is permitted. As shown in FIG. 5K, the data stored in the disk 40 is accessed (block #38, FIG. 4).

As described above, the password to compared with any input password is stored in the flash memory 24 in the first embodiment of this invention. The magnetic-disk medium unit 14 need not be operated to compare the input password with the preset one. The passwords can therefore be compared within a short time. Since the operating system is stored in the flash memory 24, the magnetic-disk medium unit 14 need not be operated before the host system 10 (i.e., computer) is activated. The operating system can therefore be executed within a short time. This shortens the time for activating the host system 10. Further, the password is stored in both the flash memory 24 and the disk 40, and the data stored in the disk 40 can be accessed only if the input password is equal to the password stored in the flash memory 24 and disk 40. Hence, even if the semiconductor medium unit 12 that stores a password equal to the input password is removed and attached to the magnetic-disk medium unit 14 of any other hard disk drive, the password stored in the unit 12 cannot be equal to the input password. Therefore, access to the data stored in the disk 40 cannot be made. This greatly enhances the security of the disk 40.

According to one aspect of the invention, a preset password is stored in a storage medium, any password input can therefore be compared with the preset password, without activating a magnetic-disk medium unit, and the data stored in the magnetic-disk medium unit can therefore be accessed within a short time after the inputting of the password.

According to another aspect of the invention, a preset password is stored in both a storage medium and a magnetic disk. After an input password is compared with the password stored in the storage medium, the magnetic-disk unit is activated. After the password stored in the storage medium is compared with the password stored in the magnetic disk, access to the magnetic-disk medium unit is permitted. Thus, the data stored in the magnetic disk cannot be accessed by using an illegal combination of the magnetic-disk medium unit and an unfit storage-medium unit.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, as shown in the flowchart of FIG. 4, the spindle motor 42 is not driven until a request for accessing the data on the disk 40 comes. Instead, the spindle motor 42 may be immediately driven to access the data on the disk 40 upon receipt of an access request, if the input password is found to be equal to the password stored in the flash memory 24 (Yes in block #26, FIG. 4).

The embodiment of this invention, described above, is a hard disk drive for use in, or use with, a personal computer. Nonetheless, this invention can be applied to a hard disk drive designed for use together with, for example, a cellular telephone, a digital music playback device for cellular telephones, or a data-processing terminal for cellular telephones.

What is claimed is:

1. A magnetic disk apparatus comprising:
a storage-medium unit including a storage medium;
a magnetic-disk medium unit including a magnetic disk medium;
a storing unit configured to store data transmitted from a host system in the storage medium;
a first comparator configured to compare an input password with a password stored in the storage medium or in a semiconductor memory provided on a substrate on which the storage medium is provided; and
a first control unit configured to control an access to the magnetic disk medium in accordance with a comparison result obtained by the first comparator.

2. A magnetic disk apparatus according to claim 1, further comprising:
a second comparator configured to compare a password stored in the magnetic disk medium with the password stored in the storage medium, when the first comparator detects that the input password is equal to the password stored in the storage medium; and
a second control unit configured to control an access to the magnetic disk medium in accordance with a comparison result of the second comparator.

3. A magnetic disk apparatus according to claim 2, further comprising:
a password storing unit configured to store a password in the storage-medium unit and the magnetic-disk medium unit.

4. The magnetic disk apparatus according to claim 3, further comprising an activation unit configured to activate the magnetic disk medium and compare the password stored in the storage medium with the password stored in the magnetic disk medium, when the input password is equal to the password stored in the storage medium.

5. The magnetic disk apparatus according to claim 4, further comprising an activation unit configured to activate the magnetic disk medium and compare the password stored in the storage medium with the password stored in the magnetic disk medium, when a request for access to the magnetic disk medium unit is received after the input password has been found to be equal to the password stored in the storage medium.

6. The magnetic disk apparatus according to claim 1, further comprising an inhibiting unit configured to inhibit an access to the data stored in the magnetic disk medium, when the input password is not equal to the password stored in the storage medium.

7. The magnetic disk apparatus according to claim 1, wherein the storage-medium unit stores addresses of data items stored in the storage-medium unit and magnetic-disk medium unit, and information representing a free storage capacity available in the storage medium.

8. The magnetic disk apparatus according to claim 1, wherein the storage medium is activated within a shorter than the magnetic disk medium is activated.

9. The magnetic disk apparatus according to claim 1, wherein the storage medium is a semiconductor memory.

10. A method of controlling a magnetic disk apparatus comprising a storage-medium unit having a storage medium and a magnetic-disk medium unit having a magnetic disk medium, the method comprising:
storing data transmitted from a host system in the storage medium;
comparing an input password with a password stored in the storage medium or in a semiconductor memory; and
controlling an access to the magnetic disk medium in accordance with the result of comparison between the input password and the password stored in the storage medium.

11. The method according to claim 10, further comprising:
comparing a password stored in the magnetic disk medium with the password stored in the storage medium, when the input password is equal to the password stored in the storage medium; and
controlling an access to the magnetic disk medium in accordance with a result of comparison between the password stored in the magnetic disk medium and the password stored in the storage medium.

12. The method according to claim 11, further comprising:
storing a password in the storage-medium unit and the magnetic-disk medium unit.

13. The method according to claim 12, further comprising activating the magnetic disk medium and comparing the password stored in the storage medium with the password stored in the magnetic disk medium, when the input password is equal to the password stored in the storage medium.

14. The method according to claim 13, further comprising activating the magnetic disk medium and comparing the password stored in the storage medium with the password stored in the magnetic disk medium, when a request for access to the magnetic disk medium unit is received after the input password has been found to be equal to the password stored in the storage medium.

15. The method according to claim 10, further comprising inhibiting an access to the data stored in the magnetic disk medium, when the input password is not equal to the password stored in the storage medium.

16. A data processing apparatus comprising:
a magnetic disk apparatus comprising
a storage-medium unit having a storage medium storing an operating system, data and a password, and
a magnetic-disk medium unit connected to the storage-medium unit and having a magnetic disk storing data and the password as stored in the storage medium;
a host system connected to the magnetic disk apparatus;
a turn-on unit configured to turn on a power supply for the magnetic-disk medium unit and the storage-medium unit when a power supply for the host system is turned on;
an input unit configured to input a password supplied from the host system, while the magnetic-disk medium unit are locked;
a first comparator configured to compare the password input by the input unit with the password stored in the storage medium;
an unlocking unit configured to unlock the magnetic-disk medium unit when the first comparator detects that the password input by the input unit is equal to the password stored in the storage medium.
an executing unit configured to execute the operating system stored in the storage medium, thereby accessing the data stored in the storage medium, after the unlocking unit has unlocked the magnetic-disk medium unit;
a second comparator configured to compare the password stored in the storage medium with the password stored in the magnetic-disk medium unit, upon receiving a request for access to the magnetic-disk medium unit; and
a controller configured to permit an access to the data stored in the magnetic-disk medium unit, when the second comparator detects that the password stored in the storage medium is equal to the password stored in the magnetic-disk medium unit.
